(19) United States
(12) Patent Application Publication
(10) Pub. No.: US 2017/0151614 A1
(43) Pub. Date: Jun. 1, 2017

(54) ADJUSTABLE FACE MILL AND METHOD OF MANUFACTURE

(71) Applicants: Douglas J. Woodruff, Atlantic Mine, MI (US); William J. Endres, Houghton, MI (US); Nick H. Helminen, Calumet, MI (US)

(72) Inventors: Douglas J. Woodruff, Atlantic Mine, MI (US); William J. Endres, Houghton, MI (US); Nick H. Helminen, Calumet, MI (US)

(73) Assignee: EIP Holdings, LLC, Houghton, MI (US)

(21) Appl. No.: 15/186,120

(22) Filed: Jun. 17, 2016

Related U.S. Application Data
(60) Provisional application No. 62/181,765, filed on Jun. 19, 2015.

(51) Int. Cl. B23C 5/24

(52) U.S. Cl. CPC B23C 5/2406; B23C 5/2424; B23C 5/2462

(57) ABSTRACT

This invention relates to face milling tools used to create a generally planar/face surface on a workpiece. Embodiments of this invention allow more teeth per unit tool diameter for certain types of cutting insert mounting styles and generally for larger cutting inserts. In particular, this invention allows the aforementioned while keeping manufacturing cost lower than it could be with some other designs, mainly by allowing manufacture of the face mill using larger tools that approach the face mill from mainly or exclusively the axial direction, thus requiring the equipment used to manufacture the cutter body to be a lower cost three-axis machine as compared to four- and five-axis machines that may be otherwise needed. Embodiments of the invention also permit adjustment of the axial positions of multiple cutting inserts and their support pockets by way of adjustment in the face mill manufacturing process. Other embodiments allow the adjustment to be made by the end-user in the field on a case-by-case basis after manufacture of the face mill is complete.

### CROSS-REFERENCE TO RELATED APPLICATION

This application is based upon and claims priority to U.S. Provisional Application Ser. No. 62/181,765 filed Jun. 19, 2015, the disclosures of which are hereby incorporated in their entirety by reference herein.

### BACKGROUND OF THE INVENTION

The invention addresses cutting tools used to create flat face/planar surfaces on workpieces. Tools used to do this are referred to as face milling tools. A face milling tool, or face mill, has one or, more generally, multiple cutting teeth around its circumference, often but not necessarily equally spaced, and positioned as desired in both the axial and radial dimensions. In many cases it is desired for all cutting teeth to be positioned such that they have the same axial positions and the same radial positions, though there are some cases where it may be desired to have specific axial and/or radial positioning of each tooth such that each is not the same as all the others.

A face mill is operated by attaching it to the spindle of a machine tool. The spindle then rotates to produce a cutting motion at a relatively high cutting speed (surface speed, or tangential speed) while the machine provides a feeding motion of the workpiece and/or the face mill, relative to the other, that occurs predominantly in the plane to which the spindle axis is perpendicular. The face mill removes a layer of material from the workpiece to create, with the tips of the cutting teeth, a new surface on the workpiece that is substantially parallel to the plane of the feeding motion.

Modern face mills are usually the “indexable” type. Such face mills are comprised of a cutter body that supports one, or often more than one, indexable cutting inserts. Cutting inserts generally have a cross-section of a particular shape, such as but not limited to triangular, square, rhombic, pentagonal, hexagonal, octagonal and circular/round, and having a thickness in the dimension generally perpendicular to the plane in which their cross-sectional shape is defined. Their size is generally set by the diameter of the inscribed circle, that is, the largest circle in the same plane of their noted shape, falling within all the edges and to which all or some the edges of the polygonal shape are tangent (or the diameter of the insert for round inserts). Cutting inserts are made of materials that are hard at room temperature, and retain their hardness at the elevated temperatures experienced during metal cutting. A cutting insert has multiple corners or edges; at a given time one corner/edge is used on each cutting insert affixed to the face mill body to perform material removal. These face mills are called “indexable” since the one or more cutting inserts can be indexed from one corner/edge to a new corner/edge when the corner/edge currently in use reaches a wear level at which it is considered consumed, and ultimately a fully used cutting insert can then be replaced with a new/fresh cutting insert and the corner/edge-to-corner/edge indexing cycle is repeated.

Cutter bodies support cutting inserts either directly or indirectly. Direct support, as shown in FIG. 1a, involves an insert pocket (see FIG. 1b) machined into the cutter body for each cutting insert to be attached. Each insert pocket is of a size and shape that allows the insert, of prescribed size and shape, to fit into the pocket with a portion (corner/edge) exposed to where chip formation takes place. The insert pocket mechanically supports the cutting insert, holding it in the desired orientation on the cutter body. There exists a means of fastening the insert to the cutter body, generally but not limited to a screw and/or pin and/or clamp. Some face mills employ a mounting module as an intermediate insert mounting component between each cutting insert and the cutter body. In this method of indirectly supporting the cutting inserts, the pockets on the cutter body have a prescribed size and shape to hold a mounting module, and each mounting module comprises the provisions to support and orient a cutting insert of a particular shape and size. In this way, a single cutter body can be adapted to hold cutting inserts of different shapes and sizes by replacing only the mounting modules. Another example of indirectly supporting the cutting insert with an intermediate insert mounting component is in rotary cutting tools where a round insert is attached to a bearinged cartridge that orients the insert relative to the cutter body and supports the cutting insert in all degrees of freedom except the rotational degree of freedom about the round insert's axis. FIG. 2 shows an example of a face mill of this type.

It is often desirable to attach as many cutting inserts to a cutter body as possible to allow the greatest productivity when using the face mill. This is often limited by the manufacturability of the insert pockets or mounting module pockets. As shown in FIG. 3 (annotated version of FIG. 1b), machining the insert pocket requires that the cutting tools needed to create the surfaces of the insert pocket be able to access the insert pocket in a direction generally tangential to the cutter body. As such, excess material must be removed, more material than actually needed to fit the cutting insert to the cutter body, for the sole purpose of manufacturability (i.e., so the cutting tools creating the insert pocket can access the pocket location with an appropriate orientation). As a result, the excess material removed to allow cutting tool access is not present to physically support another circumferentially adjacent cutting insert. The net result is fewer cutting inserts on the cutter body than might otherwise be able to fit. As the size of cutting inserts increases, the volume of excess material that needs to be removed increases, adding further to the reduction in the number of cutting inserts that can be attached to the cutter body.

FIGS. 1a, 1b and 2 show cutting inserts in a radial mounting. One way to allow more cutting inserts to be fit on a cutter body is to cut the insert pocket with tools accessing from the radial direction (or in a direction lying in a plane substantially parallel to the cutter-body radial-axial plane) and using a different type of insert clamp, such as a screw and wedge; an example is shown in FIG. 4. This too is a radial mounting of the cutting inserts (radial mounting exhibits the axis of the inscribed circle of the cutting insert being substantially tangential to the cutter body). Another approach is referred to as a tangential mounting (where the axis of the inscribed circle of the cutting insert lies in a plane that is substantially parallel to the cutter-body radial-axial plane). FIG. 5 shows an example face mill of this type (this one shows inserts literally tangential to the cutter body diameter as well as lying flat on the axial face of the face mill, both of which and anywhere in between are generally referred to as tangential mount in contrast to radial mount). In manufacturing tangential mount face mills, the tools used to create the insert pocket require access in a direction generally radially to the cutter body (or in a plane that is substantially parallel to the cutter-body radial-axial plane); in contrast, recall that radial mounting employs cutting tools in predominantly the cutter-body tangential direction to manufacture the insert pockets. In both types of face mills (FIGS. 4 and 5), access is more direct and excess material need not be removed, allowing more cutting insert pockets, per diameter of the face mill, for a given size of cutting insert. FIG. 2 is an example of a face mill that holds large cutting inserts (and their rotary mounting provision) but, by machining the mounting provisions for the rotary cartridge on a separate mounting component that is then attached to the cutter body base, a larger number of cutting inserts can be achieved than by machining the rotary mounting provisions directly into the cutter body. While this approach solves the problem of tangential tool access in manufacture, and provides some degree of modularity, this approach introduces tolerance stack-up and the provisions for compactly attaching this separate mounting component to the cutter body base are intricate and costly to manufacture on both the separate mounting component and the cutter body base.

This leads to another consideration, that is, the cost to manufacture a face mill. Besides the noted excess material that must be removed for tool access in manufacture, machining the insert pocket or mounting module pocket often requires small tools with long overhangs and at complex angles. The complex angles often require (for modern competitiveness and accuracy) more costly four- and five-axis machines. The small tools with long overhangs require lower productivity cutting conditions. All this adds to the cost of manufacture. Also associated with increasing cost of manufacture is holding tight tolerance on the large cutter body so that the multiple insert pockets, or mounting module pockets, exhibit low variation from their specified position, especially in the axial direction. In fact, some face mills are made to allow the end-user to adjust, in the field, the axial position of each cutting insert to achieve even better axial alignment than is cost effectively possible without the adjustment. The adjustment adds cost and complexity, but is deemed worthwhile, especially for tools used to produce a finishing cut on a surface where the surface finish needs to be very smooth. The total range of misalignment across all cutting inserts assembled on the face mill is called runout, and is measured as “total indicator reading” or TIR. So, axial TIR is the difference in axial position from the highest to lowest cutting insert; it is generally desired that this be zero, and in practice it is costly to achieve small values. When axial TIR gets larger, surface finish of the machined part is degraded. Radial TIR can also have a negative effect on surface finish and overall performance of the face mill, but that effect is generally secondary to the negative effect of axial TIR on surface finish.

The present invention aims to allow higher tooth count per unit cutting diameter, especially when large inserts are used, and in a way that allows efficient manufacture using generally larger tools with less overhang and on a three-axis machine (generally lower-cost than four- and five-axis machines of comparable size), while also allowing ease of achieving low variation in axial position of multiple cutting inserts by way of adjustability either during the face mill manufacturing process or by way of adjustment in the field by the end-user.

### BRIEF SUMMARY OF THE INVENTION

This invention relates to face milling tools used to create a generally planar/face surface on a workpiece. Embodiments of this invention allow more teeth per unit tool diameter for certain types of cutting insert mounting styles and generally for larger cutting inserts. In particular, this invention allows the aforementioned while keeping manufacturing cost lower than it could be with some other designs, mainly by allowing manufacture of the insert mounting provisions on the face mill using larger tools that approach the face mill from mainly or exclusively the axial direction, thus requiring the equipment used to manufacture the cutter body to be a lower cost three-axis machine as compared to four- and five-axis machines that may be otherwise needed. Embodiments of the invention also permit adjustment of the axial positions of multiple cutting inserts and their support pockets by way of adjustment in the face mill manufacturing process. Other embodiments allow the adjustment to be made by the end-user in the field on a case-by-case basis after manufacture of the face mill is complete.

### BRIEF DESCRIPTION OF THE DRAWINGS

FIG. 1a is a prior art face mill showing an example of radially-mounted cutting inserts.

FIG. 1b is a prior art face mill showing an example of radially-mounted cutting inserts (inserts removed to show insert pockets).

FIG. 2 is a prior art face mill showing an example of radially-mounted round rotating cutting inserts (one removed to show pocket).

FIG. 3 is a prior art face mill showing an example of radially-mounted cutting inserts highlighting the region of excess material that must be removed for tangential tool access in machining the insert pockets.

FIG. 4 is a prior art face mill showing an example of radially-mounted cutting inserts with radial-axial clamps that allow more inserts on the cutter.

FIG. 5 is a prior art face mill showing an example of tangentially-mounted cutting inserts with radial-axial screws that allow more inserts on the cutter (including some inserts mounted flat to the face of the mill, which are also referred to as tangential mount).

FIG. 6 shows a cutter body base with one insert support pillar and its pillar clamp indicating the step of axially inserting the insert support pillar into its pillar pocket on the body base and the pillar clamp into its clamp pocket on the body base.

FIG. 7a is an insert support pillar showing a representative insert pocket.

FIG. 7b is an insert support pillar showing one representative example of an intermediate insert mounting component pocket.

FIG. 8 shows an insert support pillar interfacing with the pocket bottom by way of a pillar spacer of desired spacer thickness so the cutting insert has the desired insert axial height.

FIG. 9a shows an insert support pillar interfacing with the pocket bottom by way of one or more spring washers, an adjustment screw, and solidifying filler material to adjust the cutting insert to its desired insert axial height.

FIG. 9b is shows an insert support pillar interfacing with the pocket bottom by way of a thick solid washer/ring made of compliant material, an adjustment screw, and solidifying filler material to adjust the cutting insert to its desired insert axial height.

FIG. 10a shows a field-adjustable insert support pillar and its interface with the pocket bottom by way of a pillar adjustment wedge that translates along the pocket bottom plane so the cutting insert may be adjusted to the desired insert axial height.

FIG. 10b shows a field-adjustable insert support pillar and its interface with the pocket bottom by way of a pillar adjustment wedge that translates along the pocket bottom plane so the cutting insert may be adjusted to the desired insert axial height.

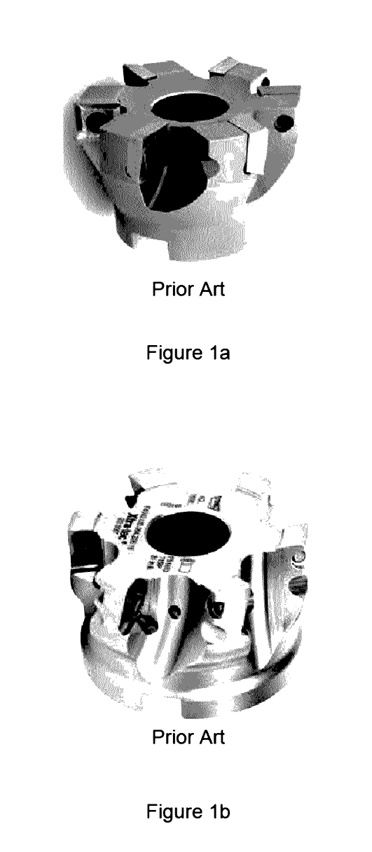

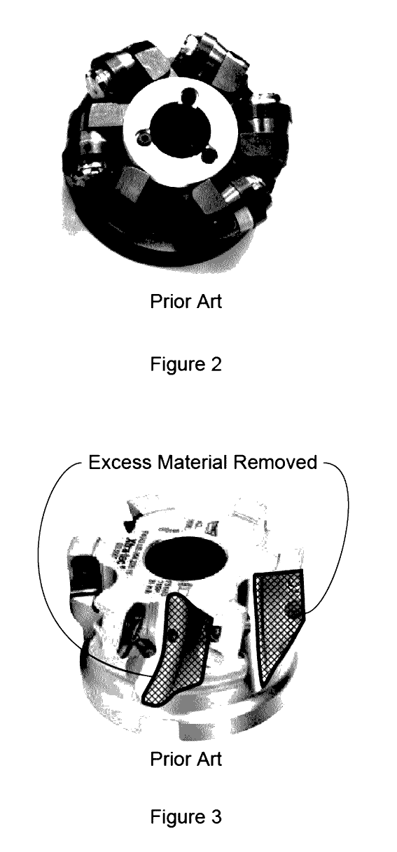

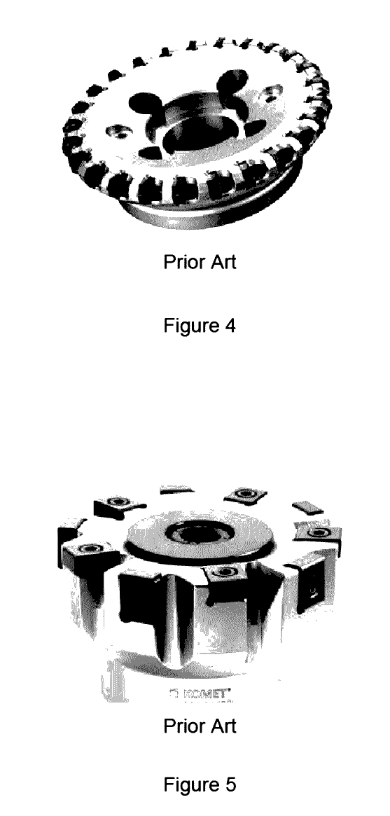

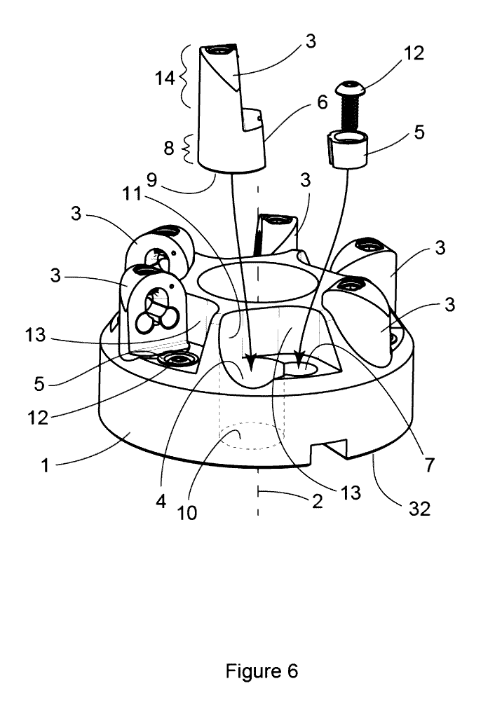

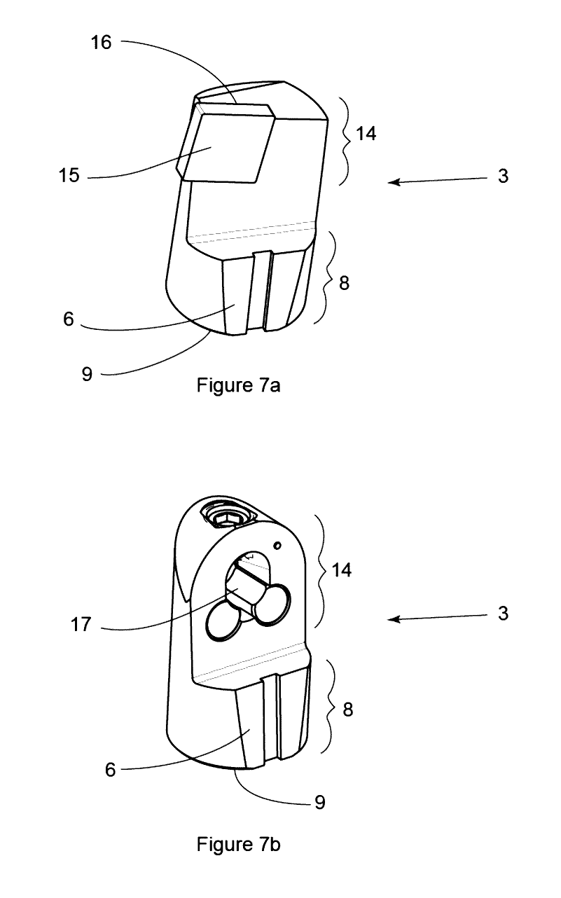

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

### DETAILED DESCRIPTION OF THE INVENTION

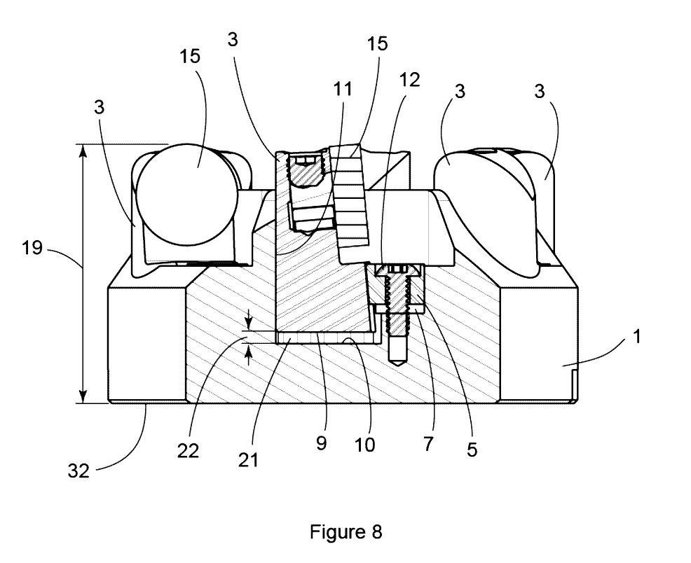

The present invention is a face mill cutter body that comprises a body base 1 that is circular or regular polygonal about cutter axis 2 and one or more insert support pillars 3, as shown in FIG. 6 (a circular body base shown). Insert support pillar 3 is generally prismatic in the direction of cutter axis 2 (cutter-axial direction). Each insert support pillar 3 fits into a pillar pocket 4 on body base 1. The cross-sectional shape of pillar bottom 8 of insert support pillar 3 matches the cross-sectional shape of pillar pocket 4. The cross-sectional size of pillar bottom 8 of insert support pillar 3 is slightly less than the cross-sectional size of pillar pocket 4 so that insert support pillar 3 can be slip fit into pillar pocket 4. Insert support pillar 3 is held in place into pillar pocket 4 with a pillar clamp 5. Pillar clamp 5 may be of various sorts, but it should contact pillar clamp receiver 6 on insert support pillar 3 in order to provide clamping force in both the cutter-axial direction and a direction lying between the cutter-radial and cutter-tangential directions. Pillar clamp 5, inserted into clamp pocket 7, forces pillar end surface 9 downward against pillar pocket bottom 10, which is generally planar in whole or in part, though not necessarily planar, and back against pillar pocket back-wall 11. Pillar clamp 5 may be affixed to body base 1 in various ways; in this case shown pillar clamp 5 is affixed to body base with pillar clamp screw 12. Other means than a threaded fastener may be used, likewise pillar clamps 5 of different style and shape may be used, with appropriate changes in the geometry of pillar clamp receiver 6, so long as the noted clamping forces are achieved. Body base 1 may have, to the extent needed, an insert clearance space 13 associated with each pillar pocket 4. When insert support pillar 3 is cylindrically shaped and, thus, in a cylindrically shaped pillar pocket 4, some means of supporting torsional loads about the axis of insert support pillar is required. In the displayed embodiment shown in FIG. 6, this is achieved through the choice of geometry associated with the interface between pillar clamp 5 and pillar clamp receiver 6.

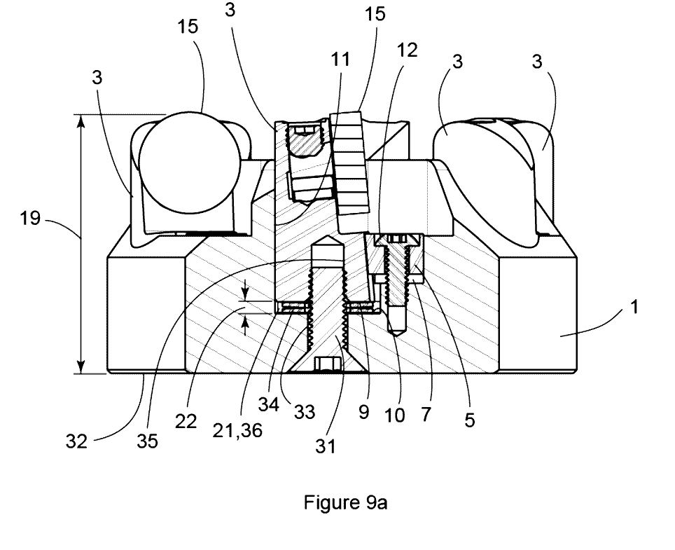

An insert support pillar 3 has at its pillar top 14 the appropriate geometry for either direct or indirect mounting of a cutting insert 15. FIG. 7a illustrates a direct mounting where the (square) cutting insert 15 is mounted directly into insert pocket 16. FIG. 7b illustrates an indirect mounting with a non-limiting example of an intermediate mounting pocket 17 that could accept an intermediate insert mounting component (not shown); the insert support/pocket provisions in this case would be incorporated in part or entirely into the intermediate insert mounting component.

In this embodiment, adjustability is achieved in assembly of the face mill as follows:

Step A: Insert an insert support pillar 3 into each pillar pocket 4.

Step B: Insert a pillar clamp 5 into each clamp pocket 7, such that it interfaces correctly with pillar clamp receiver 6 on the respective insert support pillar 3, and affix by tightening its pillar clamp screw 12 (or alternative fastening element type).

Step C: Fasten a gauge (i.e., having tight tolerance on size and shape) setting insert in insert pocket 16 of (or integrated into by way of an intermediate insert mounting component) each insert support pillar 3.

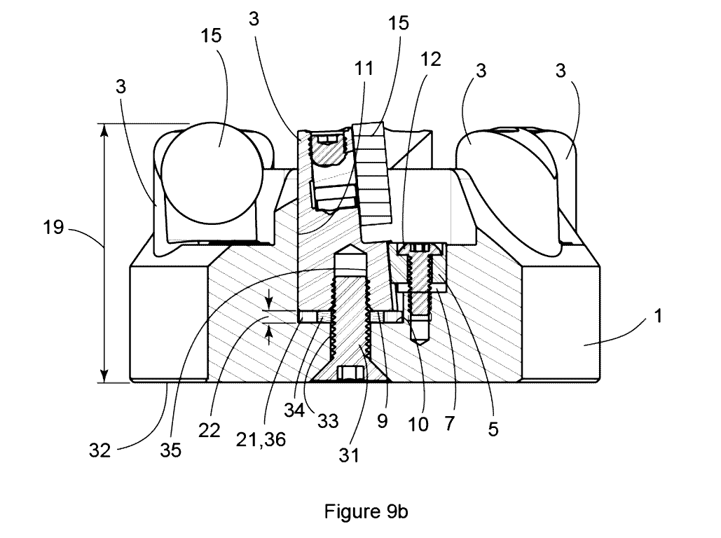

Step D: Measure and record the insert axial height 19 (see FIG. 8) of each gauge setting insert.

Step E: Remove each pillar clamp screw 12, pillar clamp 5 and insert support pillar 3.

Step F: Grind pillar end surface 9 of each insert support pillar 3 removing from its pillar end surface 9 an amount of material equal to the difference in its recorded insert axial height 19 and its desired insert axial height.

Step G: Replace all insert pillars 2 in the same pillar pockets 4 in which they were originally assembled, insert a pillar clamp 5, and affix by tightening its pillar clamp screw 12.

Note that Step C may be done earlier in the sequence and some steps can be performed on one pillar at a time.

Another embodiment is shown in FIG. 8. Here, the geometric features of body base 1 are the same as in the previous embodiment. The difference lies in the manner in which adjustment is accommodated. In this case, a pillar spacer 21 of specified spacer thickness 22 is placed into pillar pocket 4, so that is rests flat on a planar pocket bottom 10, prior to inserting insert support pillar 3 into pillar pocket 4. All other aspects of this embodiment are otherwise the same as the previous embodiment with the exception of how the adjustment is achieved in Step F. Rather than grinding material from pillar end surfaces 9, pillar spacer 21 is replaced or modified. One approach is to have a family of pillar spacers 21 at incremental levels of spacer thickness 22, and then replacing the initial pillar spacers 21 with ones of different spacer thickness 22 that provide the best adjustment of each insert axial height 19 to its desired level. In terms of axial TIR, the theoretical minimum axial TIR achievable here is the difference between each level of spacer thickness 22 in the family of pillar spacers 21. For instance, if pillar spacers 21 are made at nominal spacer thickness increments of 12 μm, then TIR can theoretically be achieved to be no larger than 12 μm. A more exact way is to perform Step F in the same way except the material is removed by grinding to reduce spacer thickness 22 rather than grinding pillar end surface 9.

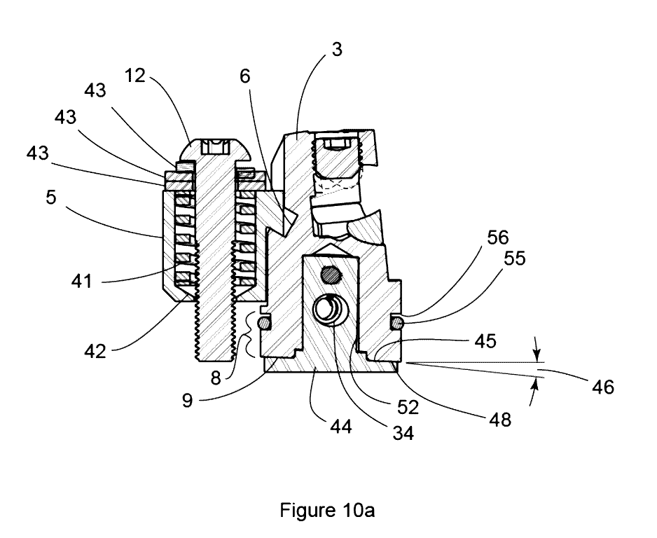

In another embodiment (see FIGS. 9a and 9b), pillar spacer 21 is created beneath insert support pillar 3 with insert support pillar 3 in place in its pillar pocket 4. In this case, there is an adjustment screw 31 that is inserted from body bottom 32 through adjustment hole 33. Adjustment screw 31 passes through adjustment spring 34 and threads into adjustment screw hole 35 through pillar end surface 9 of pillar bottom 8. Intermediate pocket bottom 10 and pillar end surface 9 is filler material 36 that solidifies over time, such as but not limited to an epoxy or other reinforced or non-reinforced polymer. While filler material 36 is still in its unhardened state, insert support pillar 3 is held upward at its desired axial position by slight compression of adjustment spring 34, which is achieved by slightly tightening adjustment screw 31 until insert support pillar 3 is at the desired height. In this axial position, no air space (other than possibly some small bubbles) should exist in filler material 36; generally some filler material 36 is squeezed out at pillar clamp receiver 6. Adjustment spring 34 can be either an actual helical spring, or a stack of spring washers as shown in FIG. 9a, or a thick solid washer/ring made of compliant material such as but not limited to rubber, neoprene, or another highly elastic or viscoelastic material (see FIG. 9b). The advantage of using a washer of compliant material is that it also serves to seal against both pocket bottom 10 and pillar end surface 9 so that filler material 36 does not come into contact with adjustment screw 31. In this way, if there is a need to disassemble after filler material 36 solidifies, adjustment screw 31 can be readily and nondestructively removed. It is good practice to apply liquid wax, mold release, or the equivalent to all surfaces of pillar pocket 4, pillar clamp 5, and pillar bottom 8 that may come into contact with filler material 36. This is acceptable since insert support pillar 3 is mechanically held in place by pillar clamp 5, not the adhesive quality of filler material 36; filler material 36 functions only to locate and support insert support pillar 3 in the cutter-axial direction. This practice will allow easy removal of insert support pillar 3 and solidified filler material 36 from pillar pocket 4 in the event of disassembly.

The method of assembly and adjustment for this embodiment is as follows:

Step A: Insert adjustment screw 31 through adjustment hole 33.

Step B: Place adjustment spring 34 over/around adjustment screw 31 such that adjustment screw 31 passes through the inner diameter of adjustment spring 34.

Step C: Fill pillar pocket 4 with filler material 36 up to just below the top of adjustment spring 34.

Step D: Lower insert support pillar 3 onto adjustment screw 31 so that adjustment screw 31 inserts into adjustment screw hole 35 through pillar end surface 9 of pillar bottom 8.

Step E: Screw adjustment screw 31 into insert support pillar 3 until adjustment spring 34 is slightly compressed, some of filler material 36 has squeezed out, and assuring that pillar clamp receiver 6 is aligned with pillar clamp 5.

Step F: Lightly press pillar clamp 5 into clamp pocket 7 but do not tighten pillar clamp screw 12 more than gentle hand/finger tightness.

Step G: Fasten a gauge (i.e., having tight tolerance on size and shape) setting insert in insert pocket 16 of (or integrated into by way of an intermediate insert mounting component) each insert support pillar 3.

Step H: Tighten adjustment screw 31 until the gauge setting insert exhibits the desired insert axial height 19.

Step I: Repeat Steps A-H for each tooth location.

Step J: Wait for filler material 36 to solidify.

Step H: Affix each insert support pillar 3 by tightening its associated pillar clamp screw 12.

Note that Step G may be done earlier in the sequence and some steps can be performed on one pillar at a time.

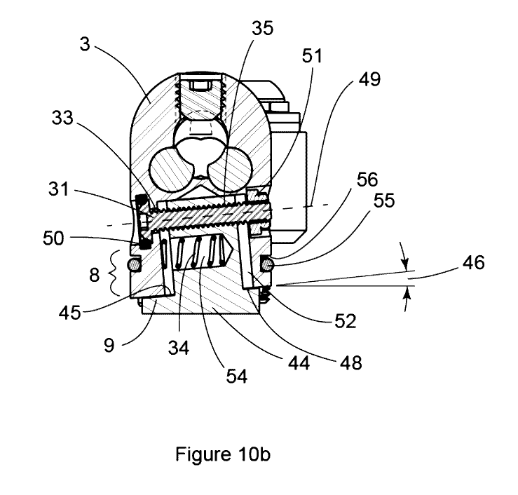

The final embodiment allows an end-user to adjust each cutting insert 15 (not shown) in the field, after the face mill is fully manufactured. This embodiment (see FIGS. 10a and 10b) has many of the same components in that they perform the same basic function, though they do so in different ways and, as such, many of the components differ from their counterparts in the previous embodiments and may be located differently than in the previous embodiments. Body base 1 again has one or more pillar pockets 4, each one of which receives an insert support pillar 3. Again, the cross-sectional shape of pillar bottom 8 of insert support pillar 3 matches the cross-sectional shape of pillar pocket 4. Furthermore, the cross-sectional size of pillar bottom 8 of insert support pillar 3 is slightly less than the cross-sectional size of pillar pocket 4 so that insert support pillar 3 can be slip fit into pillar pocket 4. Again, insert support pillar 3 is held in place into pillar pocket 4 with a pillar clamp 5 inserted into clamp pocket 7. Pillar clamp 5 again is affixed to cutter body 1 with pillar clamp screw 12 that tightens pillar clamp 5 so that, when pillar clamp 5 interfaces with insert support pillar 3 at its pillar clamp receiver 6, it forces pillar end surface 9 downward against pocket bottom 10 and back against pillar pocket back-wall 11.

The first main difference is that there is a pillar clamp spring 41 that acts in compression between the head of pillar clamp screw 12 and a pillar clamp recess 42 in pillar clamp 5. Pillar clamp spring 41 allows pillar clamp screw 12 to be loosened slightly in order to make an adjustment in insert axial height 19 while still having a substantive force, that of pillar clamp spring 41 in its compressed state, forcing pillar end surface 9 downward against pocket bottom 10 and back against pillar pocket back-wall 11. After the adjustment step is completed, pillar clamp screw 12 is retightened to lock pillar clamp 5 and, thus, insert support pillar 3 in place for use of the face mill. Some applications may include one or more pillar clamp washers 43 (including one or more flat washers and possibly a lock washer) between the top of pillar clamp spring 41 and the head of pillar clamp screw 12 so as to increase the effective diameter of pillar clamp screw 12 to be large enough (that is, larger diameter than pillar clamp recess 42) to contact, through said pillar clamp washers 43, with the top of pillar clamp 5 when tightened.

The second main difference is that pillar spacer 21 of the previous embodiments is replaced with pillar adjustment wedge 44. Pillar adjustment wedge 44 has a pillar support surface 45 that is at a wedge angle 46 relative to being parallel to adjustment wedge bottom 47. Wedge angle 46 is generally, without limitation, in the range of 1 to 17 degrees. A larger wedge angle 46 will provide a larger range of axial height adjustment, but also generally reduces the resolution of adjustment actuation. Pillar end surface 9 of pillar bottom 10 includes a wedge interface surface 48 at substantially the same (opposing) wedge angle 46 so that it mates with pillar support surface 45. As pillar adjustment wedge 44 translates back and forth along pocket bottom 10, generally in a plane to which cutter axis 2 is normal, insert support pillar 3 moves up and down.

Translation of pillar adjustment wedge 44 along pocket bottom 10 is caused by turning adjustment screw 31 that passes through adjustment hole 33 in the side of insert support pillar 3. This adjustment requires that adjustment screw 31 cannot move along its screw axis 49. This is achieved with either screw head retainer 50 or screw end retainer 51; one or the other is necessary though both may be used if desired. Both screw head retainer 50 and screw end retainer 51 also serve to seal with their mating surfaces on the outside of insert support pillar 3 to keep particles of debris, and most of the liquid that may spray on the face mill, from entering into adjustment cavity 52 that would otherwise contaminate the components contained therein. Translation of pillar adjustment wedge 44, upon turning adjustment screw 31, occurs by way of the threaded interface between adjustment screw 31 and adjustment screw hole 35 in pillar adjustment wedge 44. An adjustment spring 34 may be included, as shown in FIG. 10b, inserted into adjustment spring hole 54 in adjustment wedge 44 and compressed to make contact with the interior of insert support pillar 3 inside adjustment cavity 52. Adjustment spring 34, if included, assists in pushing adjustment wedge 44 when it is translating away from the end where the head of adjustment screw 31 is located; this adjustment spring 34 assists screw head retainer 50 in its function of inhibiting motion of adjustment screw 31 along screw axis 49 in this case when a screw end retainer 51 is not included. Note that because adjustment screw 31 is located by/with, and moves up and down with, insert support pillar 3, not with pillar adjustment wedge 44, adjustment screw hole 35 and screw axis 49 must lie in a plane that is parallel to the coplanar pillar support surface 45 and wedge interface surface 48. In this way, as pillar adjustment wedge 44 translates, causing insert support pillar 3 to rise and fall at a ratio dictated by wedge angle 46, adjustment screw hole 35 remains coaxial with screw axis 49.

Finally, in this final embodiment, one would generally include a pillar seal 55 located in seal gland 56 in the outer surface of insert support pillar 3 at pillar bottom 8. This seal may be, for example, an O-ring. Pillar seal 55 serves to keep particles of debris and most of the liquid that may spray on the face mill from entering into pillar pocket 4 and ultimately contaminating adjustment cavity 52.

The method of assembly and adjustment for this embodiment is as follows:

Step A: Insert adjustment spring 34 (if used) into adjustment spring hole 54 in adjustment pillar wedge 44, and then adjustment pillar wedge 44 into adjustment cavity 52 of insert support pillar 3, which requires some compression of adjustment spring 34.

Step B: Insert adjustment screw 31 through adjustment hole 33 in insert support pillar 3 and thread into adjustment screw hole 35 until the head of adjustment screw 31 mates with the outside of insert support pillar 3.

Step C: Install screw head retainer 50 and screw end retainer 51 (if used), the latter being mated against the outside of insert support pillar 3 tight enough such that adjustment screw 31 cannot translate along screw axis 49.

Step D: Install pillar seal 55 into seal gland 56.

Step E: Insert an assembly from Step D into each pillar pocket 4.

Step F: Insert a pillar clamp 5 into each clamp pocket 7, such that it interfaces correctly with pillar clamp receiver 6 on the respective insert support pillar 3.

Step G: Insert a pillar clamp spring 41 into pillar clamp recess 42 on each pillar clamp 5.

Step H: Insert a pillar clamp screw 12 through each pillar clamp spring 41.

Step I: For each pillar clamp 5, compress pillar clamp spring 41 with the head (possibly with a one or more flat washers 43 and possibly a lock washer 43 under it) of pillar clamp screw 12 until pillar clamp screw 12 enters the mating threads on body base 1 and can be tightened.

Step J: Tighten each pillar clamp screw 12.

Step K: Fasten a gauge (i.e., having tight tolerance on size and shape) setting insert in insert pocket 16 of (or integrated into by way of an intermediate insert mounting component) each insert support pillar 3.

Step L: Loosen each pillar clamp screw 12 an axial distance equal to the range of axial adjustment possible for the given wedge angle 46.

Step M: Turn each adjustment screw 31 until each gauge setting insert is at its desired insert axial height 19.

Step N: Tighten each pillar clamp screw 12.

Field adjustment is performed by repeating Steps L through N, as needed, generally using actual cutting inserts 15 that are used for machining by the end-user rather than gauge setting inserts that are used generally at the manufacturer.

Note that Step K may be done earlier in the sequence and some steps can be performed on one pillar at a time.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A face milling tool comprising:
a. a body that is rotatable about an axis, said body comprising:
i. a body base that is round/circular and coaxial with the axis and having one or more pillar pockets; and
ii. an insert support pillar inserted into at least one pillar pocket, the insertion occurring in the direction of the axis; and
b. a cutting insert supported by at least one insert support pillars.

2. The face milling tool of claim 1, in which body base is of regular polygonal shape concentric with the axis.

3. The face milling tool of claim 1, in which the insert support pillar has a top end with provisions for indirectly mounting at least one cutting insert and a bottom end that inserts into a pillar pocket such that the pillar end surface mates with the pocket bottom of the pillar pocket.

4. The face milling tool of claim 3, in which the top end of the insert support pillar has provisions for directly mounting at least one cutting insert.

5. The face milling tool of claim 3, in which each insert support pillar is affixed into its respective pillar pocket and to body base with a pillar clamp.

6. The face milling tool of claim 5, in which the pillar clamp interfaces with a pillar clamp receiver on its respective insert support pillar.

7. The face milling tool of claim 6, in which intermediate the pillar end surface and pocket bottom is a spacer.

8. The face milling tool of claim 7, in which the pocket bottom of a pillar pocket has at least a portion lying in a plane to which the axis is normal.

9. The face milling tool of claim 8, in which an adjustment screw passes through the body bottom, through an adjustment spring located within a hole in the spacer to communicate between the pocket bottom and the pillar end surface, the adjustment screw fastening into an adjustment screw hole in the pillar end surface.

10. The face milling tool of claim 9, in which the spacer comprises a filler material that solidifies over time.

11. The face milling tool of claim 6, in which, inside an adjustment cavity in the pillar bottom and extending to be intermediate the pillar end surface and pocket bottom, is an adjustment wedge.

12. The face milling tool of claim 11, in which the adjustment wedge has an adjustment wedge bottom in contact with at least a portion of the planar pocket bottom and a pillar support surface oriented at a wedge angle relative to the adjustment wedge bottom, the pillar support surface being in contact with a mating wedge interface surface on the end surface of the insert support pillar.

13. The face milling tool of claim 12, in which the adjustment wedge includes an adjustment screw hole that receives an adjustment screw that passes through an adjustment hole in the outer wall of the insert support pillar.

14. The face milling tool of claim 13, in which the adjustment screw is retained along its screw axis by a screw head retainer on the outside of insert support pillar.

15. The face milling tool of claim 14, in which each pillar clamp is affixed to the body base by way of a pillar clamp screw acting through a pillar clamp spring.

16. The face milling tool of claim 15, in which one or more pillar clamp washers exist intermediate the top of the pillar clamp spring and the underside of the head of the pillar clamp screw.

17. The face milling tool of claim 16, in which an adjustment spring exists intermediate the adjustment wedge and the interior wall of the adjustment cavity in the bottom end of the insert support pillar.

18. A face milling tool comprising:
a. a body that is rotatable about an axis, said body comprising:
i. a body base that is round/circular and coaxial with the axis and having one or more pillar pockets; and
ii. an insert support pillar inserted into at least one pillar pocket, the insertion occurring in the direction of the axis; and
b. a cutting insert supported by at least one insert support pillars, at least one of which comprising:
i. an adjustment cavity in the pillar bottom; and
ii. an adjustment wedge inside the adjustment cavity and extending to be intermediate the pillar end surface and pocket bottom.

19. The face milling tool of claim 18, in which the adjustment wedge has an adjustment wedge bottom in contact with at least a portion of the planar pocket bottom and a pillar support surface oriented at a wedge angle relative to the adjustment wedge bottom, the pillar support surface being in contact with a mating wedge interface surface on the end surface of the insert support pillar.

20. The face milling tool of claim 19, in which the insert support pillar has a top end with provisions for indirectly mounting at least one cutting insert and a bottom end that inserts into a pillar pocket.
